(19) United States
(12) Patent Application Publication
(10) Pub. No.: US 2015/0263407 A1
(43) Pub. Date: Sep. 17, 2015

(54) RESONATOR INCLUDING VERTICALLY OR HORIZONTALLY ALTERNATING PARTITION WALLS AND FILTER USING THE SAME

(71) Applicant: WAVE ELECTRONICS CO., LTD., Suwon-si (KR)

(72) Inventors: Dal Ahn, Seoul (KR); Yun Hong Yang, Seoul (KR); Seok Hwi Kim, Gimje-si (KR); Ki Suk Kim, Suwon-si (KR)

(73) Assignee: WAVE ELECTRONICS CO., LTD.

(21) Appl. No.: 14/641,654

(22) Filed: Mar. 9, 2015

(30) Foreign Application Priority Data
Mar. 11, 2014 (KR) 10-2014-0028124

(51) Int. Cl. H01P 7/06; H01P 1/20

(52) U.S. Cl. CPC H01P 7/06; H01P 1/207

(57) ABSTRACT

The present invention relates to a resonator and a filter using the same, and particularly, to a resonator, which includes partition walls that alternate vertically or horizontally in a cavity, and a filter using the resonator. The resonator includes: a housing which is made of a conductive material and includes a cavity; a cover which is made of a conductive material and fixed to an upper portion of the cavity, and seals the cavity; one or more first partition walls which are connected to one surface of inner surfaces of the cavity; and one or more second partition walls which are connected to the opposite surface to the one surface, in which the first partition walls and the second partition walls are made of a conductive material and have shapes corresponding to each other, and the first partition walls and the second partition walls alternate with each other.

### REFERENCE TO RELATED APPLICATIONS

This application claims the priority benefit of Korean Patent Application No. 10-2014-0028124 filed on Mar. 11, 2014, the entire contents of which are incorporated herein by reference.

### FIELD OF THE INVENTION

The present invention relates to a resonator and a filter using the same, and particularly, to a resonator, which includes partition walls that alternate vertically or horizontally in a cavity, and a filter using the resonator.

### BACKGROUND OF THE INVENTION

Recently, with popularization and sophistication of mobile communication services, various researches are being conducted on high frequency elements in order to implement wireless communication systems. One example of the high frequency elements is a resonator which constitutes a high frequency filter or the like that is used at a sending end of a base station.

The resonator may be widely used to constitute a filter in an electric circuit, or included in an oscillator. The resonator for processing small signals with low electric power may be implemented in the form of an LC resonant circuit or the like, but in a case in which the resonator needs to process high power signals at the sending end of the base station, a cavity resonator using a cavity made of a conductive material, a waveguide resonator, or the like is used. However, in the case of the cavity resonator or the waveguide resonator as described above, a size of the resonator is in proportion to a wavelength of the signal to be processed, and as a result, the resonator has a significantly large volume in comparison with a case in which the resonator is typically configured by using an LC unit element (lumped element) or the like. In order to solve the aforementioned problem, there was an attempt to perform a method of using a dielectric resonator (DR) that includes a resonant element configured with a dielectric substance with high permittivity, or a method of miniaturizing the resonator or the filter by using a dielectric resonant element that resonates in a dual resonance mode or a multi-resonance mode. Korean Patent Application Laid-Open No. 2003-0078346 (published on Oct. 8, 2003) discloses a resonator, which is miniaturized by including a dielectric resonance element that is operated in a multi-resonance mode in a cavity, and a filter using the resonator. Further, FIG. 1 illustrates a structure of the filter according to the laid-open patent application, which includes the dielectric resonance element that is operated in the multi-resonance mode. In addition, it is possible to take into account a method of further reducing the size of the resonator by implementing a stepped impedance resonator (SIR) by connecting dielectric substances having a difference in impedance properties.

However, in a case in which the resonator is configured by using a dielectric substance as described above, the dielectric resonance element (resonator) needs to be inserted into the cavity, and as a result, there are basic problems in that the resonator may be heavy, it is difficult to mass-produce the resonator because of difficulty in processing the dielectric resonance element due to the property of a dielectric material, manufacturing costs are increased, and an ineffective resonance mode may occur because of the inherent physical property of the dielectric substance.

Accordingly, there is a need for a resonator, which has a structure to be configured without using the dielectric resonance element, thereby minimizing the size of the resonator, reducing weight of the resonator, allowing the resonator to be suitable for mass production, and reducing manufacturing costs, and a filter using the resonator. However, an appropriate solution for the aforementioned need is not yet presented.

### SUMMARY OF THE INVENTION

The present invention has been made in an effort to provide a resonator which may be configured without using a dielectric resonance element, thereby minimizing the size of the resonator, reducing weight of the resonator, allowing the resonator to be suitable for mass production, and reducing manufacturing costs, and a filter using the same.

An exemplary embodiment of the present invention provides a resonator including: a housing which is made of a conductive material and includes a cavity; a cover which is made of a conductive material and fixed to an upper portion of the cavity, and seals the cavity; one or more first partition walls which are connected to one surface of inner surfaces of the cavity; and one or more second partition walls which are connected to the opposite surface to the one surface, in which the first partition walls and the second partition walls are made of a conductive material and have shapes corresponding to each other, and the first partition walls and the second partition walls alternate with each other.

The first partition walls may form lower partition walls which are connected to the lower surface of the inner surfaces of the cavity, the second partition walls may form upper partition walls which are connected to the cover, and the lower partition walls and the upper partition walls may vertically alternate with each other.

The first partition walls and the second partition walls may have a circular pipe shape, a polygonal pipe shape, a flat shape or a curved shape.

The resonator may further include a tuning bolt which tunes frequency properties of the resonator.

The tuning bolt may be positioned to penetrate the cover.

A height of the first partition wall and a height of the second partition wall may be smaller than a height of the cavity, and the sum of the height of the first partition wall and the height of the second partition wall may be greater than the height of the cavity.

The first partition wall and the second partition wall may have a periodic structure.

Some partition walls of the first partition walls and the second partition walls may deviate from a periodic structure in terms of a height, a thickness, and an interval thereof.

An edge at an end of each of the first partition walls and the second partition walls may have a curved shape.

Another exemplary embodiment of the present invention provides a filter which uses a resonator, the resonator including: a housing which is made of a conductive material and includes one or more cavities; a cover which is made of a conductive material and fixed to an upper portion of the cavity, and seals the cavity; one or more first partition walls which are connected to one surface of inner surfaces of the cavity; one or more second partition walls which are connected to the opposite surface to the one surface; and a connector which inputs and outputs a signal, in which the first partition walls and the second partition walls are made of a conductive material and have shapes corresponding to each other, and the first partition walls and the second partition walls alternate with each other.

The first partition walls may be connected to the lower surface of the inner surfaces of the cavity and may form lower partition walls, the second partition walls may be connected to the cover and may form upper partition walls, and the lower partition walls and the upper partition walls may vertically alternate with each other.

The first partition walls and the second partition walls may have a circular pipe shape, a polygonal pipe shape, a flat shape or a curved shape.

The filter may further include a tuning bolt which tunes frequency properties of the filter.

The present invention may disclose the resonator and the filter using the same, the resonator being configured by using a structure in which partition walls alternate vertically or horizontally inside the cavity of the conductive material, such that the resonator may be configured without using the dielectric resonance element, thereby minimizing the size of the resonator, reducing weight of the resonator, allowing the resonator to be suitable for mass production, and reducing manufacturing costs.

### BRIEF DESCRIPTION OF THE DRAWINGS

The accompanying drawings, which are included as a part of the detailed description for helping to understand the present invention, provide exemplary embodiments of the present invention and describe the technical spirit of the present invention together with the detailed description.

FIG. 1 is a schematic view of a multiple resonance mode dielectric filter according to the related art.

FIG. 2 is a structural view of a resonator according to an exemplary embodiment of the present invention, which has a structure in which partition walls alternate vertically.

FIG. 3 is a structural view of the resonator according to the exemplary embodiment of the present invention, which has a structure with circular pipe-shaped partition walls.

FIGS. 4A, 4B, 4C are exemplified views of the resonator according to the exemplary embodiments of the present invention, illustrating a structure with partition walls having various shapes.

FIG. 5 is a structural view of the resonator according to the exemplary embodiment of the present invention, which has a structure in which partition walls having a curved end alternate vertically.

FIG. 6 is a simulation model of the resonator according to the exemplary embodiment of the present invention, which has a structure with circular pipe-shaped partition walls.

FIG. 7 is a graph showing a result of electric field distribution simulation for the resonator with the structure having the circular pipe-shaped partition walls of FIG. 6.

FIG. 8 is a picture of a prototype of the resonator according to the exemplary embodiment of the present invention, which has a structure with circular pipe-shaped partition walls.

FIG. 9 is a graph showing measured frequency properties of the resonator according to the exemplary embodiment of the present invention, which has a structure with circular pipe-shaped partition walls.

FIG. 10 is a perspective view of a filter using the resonator according to the exemplary embodiment of the present invention, which has a structure with circular pipe-shaped partition walls.

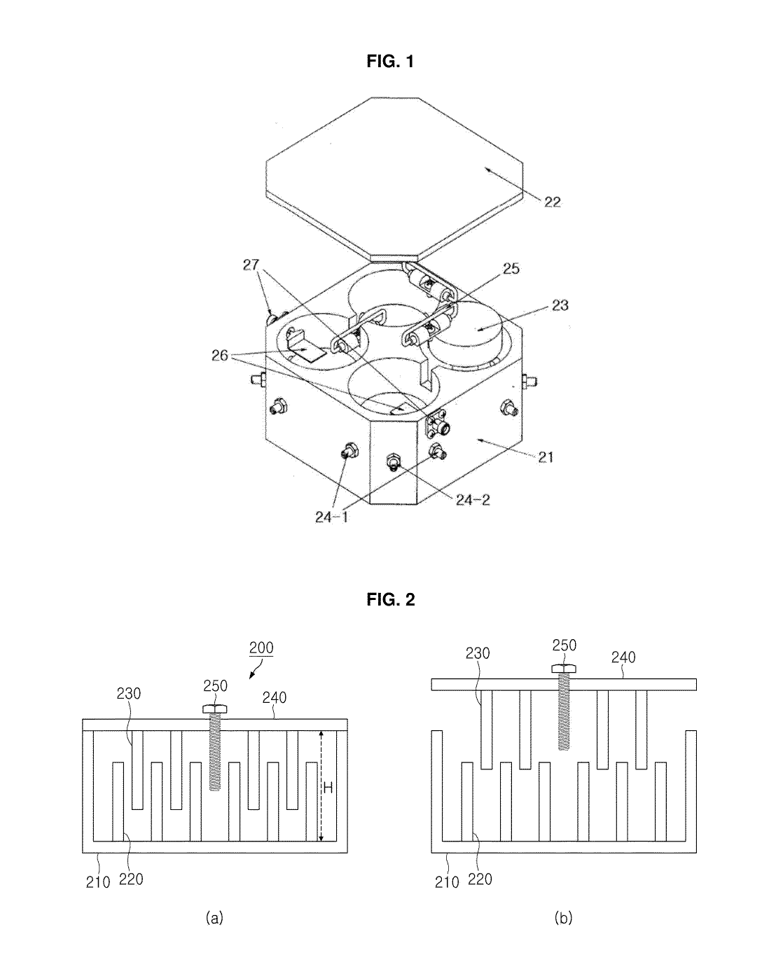

### DETAILED DESCRIPTION OF THE INVENTION

The present invention may have various modifications and a variety of exemplary embodiments, and thus specific exemplary embodiments will be described in detail below with reference to the accompanying drawings.

In the description of the present invention, the specific descriptions of publicly known related technologies will be omitted when it is determined that the specific descriptions may obscure the subject matter of the present invention.

The terms “first”, “second”, and the like may be used to describe various constituent elements, but the constituent elements are not limited by the terms, and the terms are used only for the purpose of discriminating one constituent element from another constituent element.

In the related art, when a resonator for processing high power signals is configured, a cavity resonator, which uses a cavity made of a conductive material, or a waveguide resonator may be used, but in this case, there is a problem in that a size of the resonator may be increased. In order to cope with the problem, in a case in which the resonator is configured with a dielectric resonance element so as to reduce the size of the resonator, the dielectric resonance element needs to be inserted into the cavity, and as a result, there are problems in that the resonator may be heavy, it is difficult to mass-produce the resonator because of difficulty in processing the dielectric resonance element due to properties of a dielectric material, manufacturing costs are increased, and an ineffective resonance mode may occur because of the inherent physical properties of the dielectric substance. In consideration of the aforementioned problems, the present invention discloses a resonator and a filter using the same, the resonator being configured by using a structure in which partition walls alternate vertically or horizontally inside the cavity made of the conductive material, such that the resonator may be configured without using the dielectric resonance element, thereby minimizing the size of the resonator, reducing weight of the resonator, allowing the resonator to be suitable for mass production, and reducing manufacturing costs.

FIG. 2 illustrates a structural view of a resonator 200 according to an exemplary embodiment of the present invention, which has a structure in which partition walls alternate vertically. As illustrated in FIG. 2, the resonator 200, which has the structure in which the partition walls alternate vertically, includes a housing 210 which is made of a conductive material and includes a cavity, a cover 240 which is made of a conductive material and fixed to an upper portion of the cavity, and seals the cavity, one or more lower partition walls 220 which are attached to a lower surface of inner surfaces of the cavity, and one or more upper partition walls 230 which are attached to the cover. The lower partition walls 220 and the upper partition walls 230 are made of a conductive material, and have shapes corresponding to each other. The lower partition walls 220 and the upper partition walls 230 may vertically alternate with each other. Furthermore, the resonator may further include a tuning bolt 250 which tunes frequency properties of the resonator.

While FIG. 2 illustrates the resonator 200 having the partition walls that alternate vertically, the partition walls, which alternate vertically inside the cavity, are formed by just physically rotating a structure in which the partition walls alternate horizontally, and there is no difference in terms of resonance properties between the partition walls, which alternate vertically, and the partition walls that alternate horizontally. Therefore, even though the resonator is configured with the partition walls that alternate horizontally or laterally, the resonator has the same properties as the resonator, which is configured with the partition walls that alternate vertically, without having a specific difference. Accordingly, hereinafter, only the resonator 200 with the structure in which the partition walls alternate vertically or in an up and down direction will be described instead of separately describing the resonator with the structure in which the partition walls alternate horizontally.

Hereinafter, the resonator 200 according to the exemplary embodiment of the present invention, which has the structure in which the partition walls alternate vertically, will be described in detail for each part thereof. First, the housing 210, which is made of a conductive material and includes the cavity, will be described. The housing 210, together with the cover 240 fixed to the upper portion of the cavity, shields an electromagnetic field formed in the cavity from the outside, and furthermore, serves as a heat radiating structure capable of effectively radiating heat generated by the high power signal. The housing 210 is typically and mostly made of, but not necessarily limited to, metal or an alloy that is excellent in electrical conductivity and advantageous in terms of heat radiation. Furthermore, the inner surface or the like of the cavity may be coated with silver (Ag) or the like in order to increase electrical conductivity. Since the housing 210 may be configured in accordance with the related art without great difficulty, the housing 210 will not be described in detail herein.

Next, the cover 240, which is made of a conductive material and fixed to the upper portion of the cavity, and seals the cavity, will be described. As described above, the cover 240, together with the housing 210, shields an internal space of the cavity, and also serves as a structure for fixing the upper partition walls 230. Furthermore, the tuning bolt 250 may be coupled to the cover 240 so as to penetrate the cover 240. The cover 240 is typically and usually made of a material identical to the material of the housing 210 in consideration of thermal expansion properties, and as a result, the cover 240 is mostly made of metal or an alloy, but not necessarily limited thereto. In addition, the cover 240 may be coated with silver (Ag) in order to increase electrical conductivity. Furthermore, the cover 240 is typically and usually fixed to the housing 210 by using screws or the like, but instead of the screws, the cover 240 may be fixed by various methods in consideration of manufacturing processes such as welding processes, and electrical and mechanical properties of the product. Since the cover 240 may also be configured in accordance with the related art without great difficulty, the cover 240 will not be described in detail herein.

Next, the one or more lower partition walls 220 attached to the lower surface of the inner surfaces of the cavity, and the one or more upper partition walls 230 attached to the cover will be described. As illustrated in FIG. 2A, the lower partition walls 220 and the upper partition walls 230, which are made of a conductive material such as metal, have shapes corresponding to each other, and are attached to the upper and lower surfaces in the cavity to form the structure in which the lower partition walls 220 and the upper partition walls 230 vertically alternate with each other, thereby forming a resonance structure. If the lower partition wall 220 and the upper partition wall 230 are not present, a resonant frequency and a resonance mode may be determined based on a shape of the cavity, such as a width, a depth, a height, and the like. However, as described above, the structure in which the lower partition walls 220 and the upper partition walls 230 alternate with each other serves as a ground contact surface, such that distribution of an internal electromagnetic field is greatly changed, and as a result, the resonant frequency may be greatly decreased. Typically, a size of the cavity needs to be increased in proportion to a resonant wavelength in order to decrease the resonant frequency. However, according to the present invention, even though the cavity, which has the same size as the typical cavity, is used, it is possible to greatly decrease the resonant frequency using the structure in which the lower partition walls 220 and the upper partition walls 230 alternate with each other.

In order to effectively miniaturize the resonator by using the structure in which the lower partition walls 220 and the upper partition walls 230 alternate with each other, a height of the lower partition wall 220 and a height of the upper partition wall 230 are smaller than a height (H in FIG. 2A) of the cavity, but the sum of the height of the lower partition wall 220 and the height of the upper partition wall 230 is greater than the height of the cavity, such that the lower partition wall 220 and the upper partition wall 230 may partially overlap each other.

In this case, the upper partition walls 230 and the lower partition walls 220 may have periodic structures in terms of heights, thicknesses, intervals, and the like thereof. Furthermore, as necessary, by changing heights, thicknesses, and intervals of some partition walls, it is possible to change operational properties of the resonator such as the resonant frequency.

FIG. 2B illustrates a case in which the housing 210 and the cover 240 are separated. As illustrated in FIG. 2B, the upper partition walls 230 may be fixed to the cover 240 by being attached to the cover 240, but the present invention is not necessarily limited thereto, and the upper partition walls 230 and the cover 240 may be integrally manufactured, as necessary. Likewise, the lower partition wall 220 may also be fixed to the housing 210 by being attached to the housing 210, but the lower partition walls 220 and the housing 210 may be integrally manufactured, as necessary.

As illustrated in FIGS. 2A and 2B, the tuning bolt 250 may be fixed to the cover 240 so as to penetrate the cover 240. Furthermore, it is possible to precisely adjust operational properties of the resonator such as the resonant frequency by rotating the tuning bolt 250 and vertically adjusting the tuning bolt 250 along a central axis of the tuning bolt 250.

However, the tuning bolt 250 does not necessarily need to penetrate the cover 240 or does not need to be necessarily positioned on the central axis of the upper partition walls 230 and the lower partition walls 220. Furthermore, the resonator 200 may include a plurality of tuning bolts 250. Accordingly, the tuning bolt 250 may penetrate a certain surface of the housing 210, and the plurality of tuning bolts 250 may penetrate at a predetermined position of the cover 240 or the housing 210.

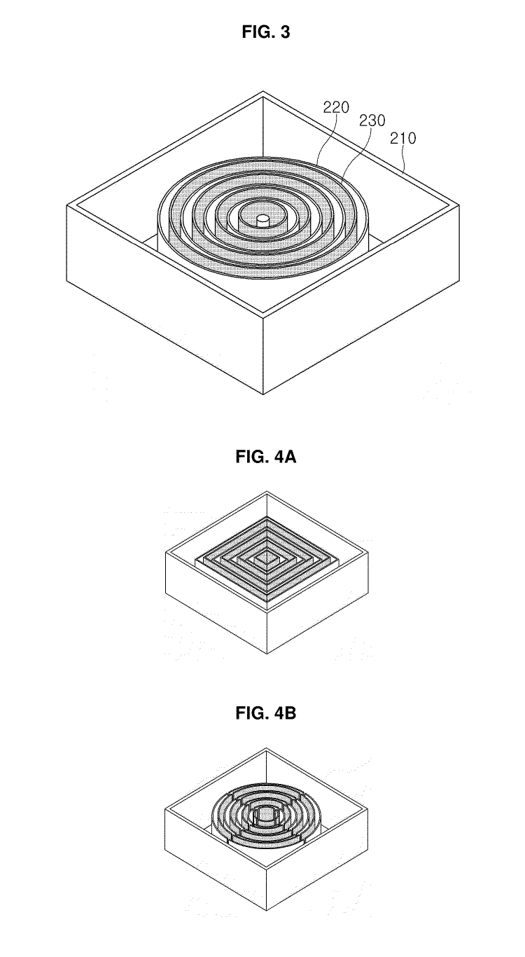

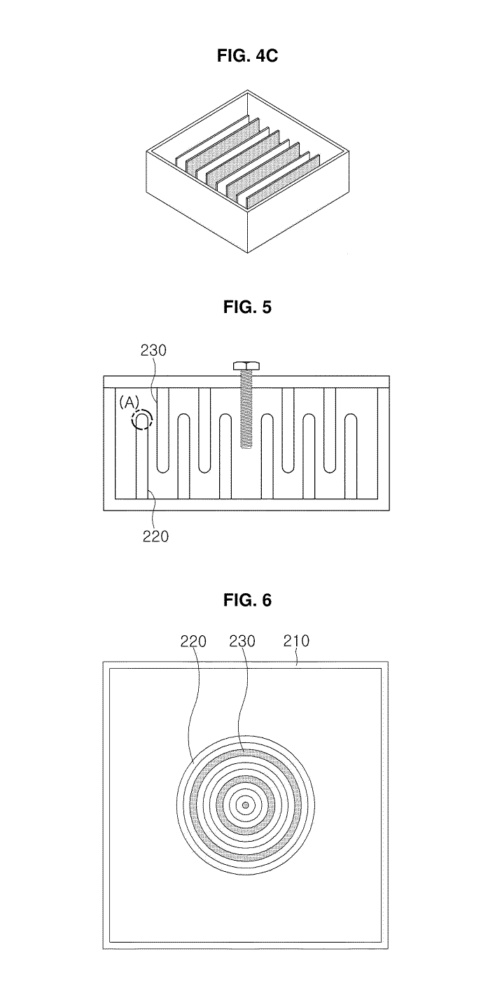

The upper partition walls 230 and the lower partition walls 220 may have various shapes, and FIG. 3 illustrates the structure of the resonator according to the exemplary embodiment of the present invention, which has circular pipe-shaped partition walls. However, the aforementioned structure of the resonator is merely one example, and various structures may be used as long as the upper partition walls 230 and the lower partition walls 220 have shapes corresponding to each other and alternate vertically. As necessary, the resonator may also be configured by using various structures with circular pipe-shaped partition walls, polygonal pipe-shaped partition walls, and partition walls having a flat or curved shape, such as a structure with quadrangular pipe-shaped partition walls (FIG. 4A), a structure in which curved-shaped partition walls are disposed to form concentric circles (FIG. 4B), and a structure with flat-shaped partition walls (FIG. 4C). In addition, as illustrated in FIGS. 3 and 4, and as described above, the lower partition walls 220 are attached to the lower surface of the cavity, the upper partition walls 230 are attached to the cover 240, and the lower partition walls 220 and the upper partition walls 230 alternate vertically. Therefore, it is possible to greatly decrease the resonant frequency of the resonator even though the cavity, which has the same size as the typical cavity, is used.

FIG. 5 illustrates a structural view of the resonator according to the exemplary embodiment of the present invention, which has partition walls that alternate vertically and have curved ends. As illustrated in FIG. 5, an edge (Part A in FIG. 5) at the end of each of the upper partition walls 230 and the lower partition walls 220 may have a curved shape. In a case in which the resonator is configured in accordance with the exemplary embodiment of the present invention, loss properties of the resonator may be slightly decreased based on a specific design and implementation. However, by using the structure with the partition walls having the curved ends as described above, it is possible to improve loss properties of the resonator according to the present invention.

In a case in which the resonator 200 is configured with the structure in which the partition walls alternate vertically in accordance with the exemplary embodiment of the present invention, the number of partition walls is increased, and as a result, it is possible to inhibit harmonic components (2f0, 3f0, . . . ) or the like with respect to a basic frequency (f0) of the resonator, thereby improving signal properties such as phase noise properties of a communication system, and improving performance of the entire system by inhibiting system noise.

In a case in which the resonator 200 is configured with the structure in which the plurality of partition walls alternates vertically in accordance with the exemplary embodiment of the present invention, it can be confirmed through simulation and prototypes that as the number of partition walls is increased, it is possible to effectively inhibit the harmonic components of the resonator.

FIG. 6 illustrates a simulation model of the resonator according to the exemplary embodiment of the present invention, which has the structure with circular pipe-shaped partition walls. In this case, when a size of the cavity of the resonator is 84 mm×84 mm×13 mm, radii of the upper and lower partition walls are 17 mm, 15 mm, 13 mm, 11 mm, and 9 mm from the outer partition wall, respectively, a width of each of the partition walls is 1 mm, a height of each of the partition walls is 12 mm, and a diameter of the tuning bolt 250 at a central portion is 4 mm, it can be confirmed from the simulation result that the resonant frequency of the present resonator is about 468 MHz. In this case, as a simulation tool, high frequency structure simulation (HFSS), which is a finite element method (FEM) analysis program commercially available from Ansys Inc., was used.

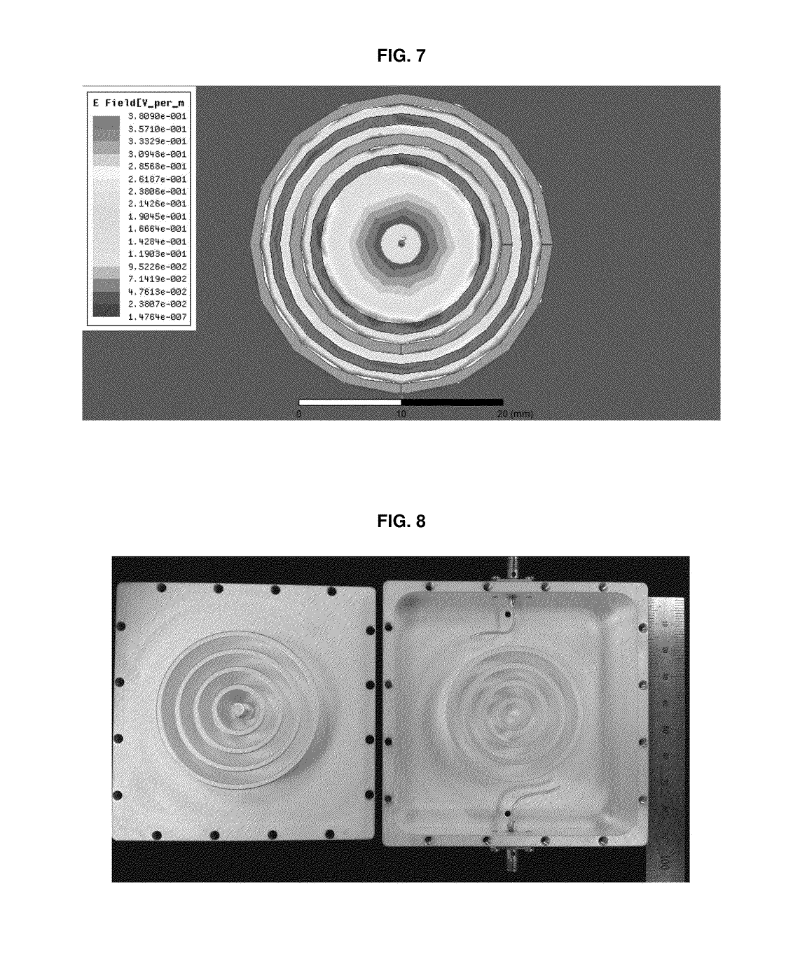

FIG. 7 illustrates a graph showing a result of electric field distribution simulation for the resonator with the structure having the circular pipe-shaped partition walls of FIG. 6. As illustrated in FIG. 7, it can be confirmed that electric field distribution is rapidly changed according to the structure in which the upper and lower partition walls alternate. Accordingly, it can be seen that even though the cavity, which has the same size as the typical cavity, is used, the resonator is configured with the structure in which the partition walls alternate vertically, in accordance with the present invention, thereby greatly decreasing the resonant frequency.

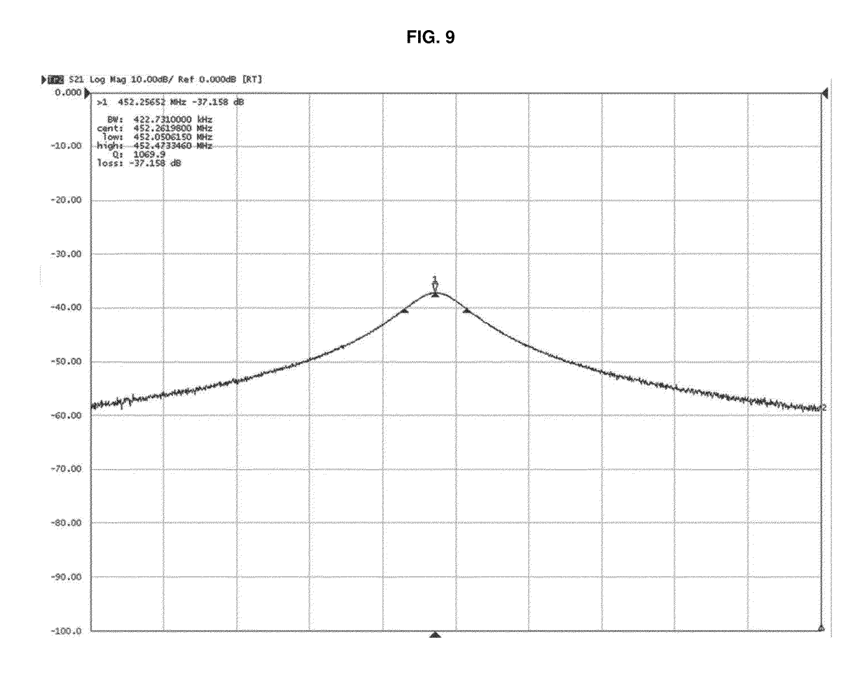

FIG. 8 illustrates a picture of a prototype of the resonator according to the exemplary embodiment of the present invention, which has a structure with circular pipe-shaped partition walls, and FIG. 9 illustrates a graph showing measured frequency properties of the prototype. As illustrated in FIG. 8, the prototype is manufactured to have the same structure as illustrated in FIGS. 2 and 3, a size of the prototype is about 100 mm×100 mm×25 mm, and a size of an internal cavity is 84 mm×84 mm×13 mm. In this case, as illustrated in FIG. 9, it can be seen that the resonant frequency of the present prototype is about 450 MHz. In contrast, in a case in which the resonator is configured to have the same size as the present prototype, but have a structure having only a vacant space without having the upper partition wall 230 and the lower partition wall 220 in the cavity, the resonant frequency is about 1.78 GHz at a TE100 mode when the resonant frequency is simulated. Accordingly, it can be confirmed that it is possible to greatly decrease the resonant frequency by configuring the resonator by using the structure, in which the partition walls alternate vertically, in accordance with the present invention.

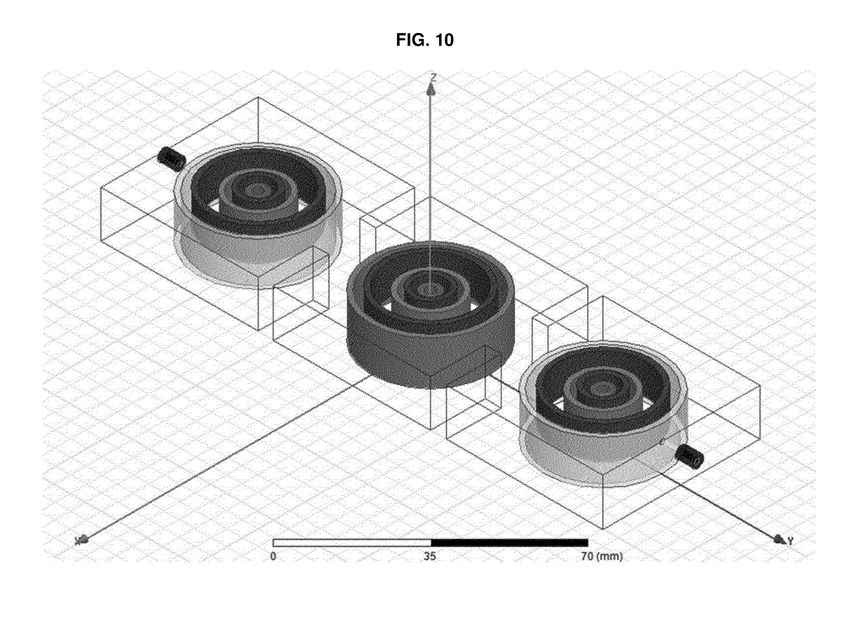

Next, FIG. 10 illustrates a filter using the resonator according to the exemplary embodiment of the present invention, which has a structure with circular pipe-shaped partition walls. The filter according to the exemplary embodiment of the present invention may include a housing which is made of a conductive material and includes one or more cavities, a cover which is made of a conductive material and positioned on an upper portion of the cavity, and seals the cavity, a plurality of lower partition walls which is attached to a lower surface of inner surfaces of the cavity, a plurality of upper partition walls which is attached to the cover, and a connector which inputs and outputs signals. The lower partition walls and the upper partition walls are made of a conductive material, and have shapes corresponding to each other. In addition, the lower partition walls and the upper partition walls vertically alternate with each other. In this case, the upper partition walls and the lower partition walls may have various shapes such as a circular pipe shape, a polygonal pipe shape, a flat shape, a curved shape, and the like.

The filter may further include one or more tuning bolts which tunes frequency properties of the filter.

Accordingly, the resonator or the filter using the resonator is configured with the structure in which the lower partition walls and the upper partition walls have shapes corresponding to each other and vertically alternate with each other inside the cavity, thereby greatly decreasing the sizes of the resonator and the filter. In addition, since the resonator is configured without using a dielectric substance or the like, it is possible to implement the resonator and the filter that are light in weight, suitable for mass production, and may reduce manufacturing costs.

Although an exemplary embodiment of the present invention has been described for illustrative purposes, those skilled in the art will appreciate that various modifications and changes are possible, without departing from the scope and spirit of the invention. Accordingly, the exemplary embodiments disclosed in the present invention are not intended to limit but describe the technical spirit of the present invention, and the scope of the technical spirit of the present invention is not limited by the exemplary embodiments. The protection scope of the present invention should be construed based on the following appended claims and it should be appreciated that all the technical spirit included within the scope equivalent to the claims belongs to the scope of the present invention.

What is claimed is:

1. A resonator comprising:
a housing which is made of a conductive material and includes a cavity;
a cover which is made of a conductive material and fixed to an upper portion of the cavity, and seals the cavity;
one or more first partition walls which are connected to one surface of inner surfaces of the cavity; and
one or more second partition walls which are connected to the opposite surface to the one surface,
wherein the first partition walls and the second partition walls are made of a conductive material and have shapes corresponding to each other and, the first partition walls and the second partition walls alternate with each other.

2. The resonator of claim 1, wherein the first partition walls form lower partition walls which are connected to the lower surface of the inner surfaces of the cavity, the second partition walls form upper partition walls which are connected to the cover, and the lower partition walls and the upper partition walls vertically alternate with each other.

3. The resonator of claim 1, wherein the first partition walls and the second partition walls have a circular pipe shape, a polygonal pipe shape, a flat shape or a curved shape.

4. The resonator of claim 1, further comprising:
a tuning bolt which tunes frequency properties of the resonator.

5. The resonator of claim 4, wherein the tuning bolt is positioned to penetrate the cover.

6. The resonator of claim 1, wherein a height of the first partition wall and a height of the second partition wall are smaller than a height of the cavity, and the sum of the height of the first partition wall and the height of the second partition wall is greater than the height of the cavity.

7. The resonator of claim 1, wherein the first partition wall and the second partition wall have a periodic structure.

8. The resonator of claim 7, wherein some partition walls of the first partition walls and the second partition walls deviate from a periodic structure in terms of a height, a thickness, and an interval thereof.

9. The resonator of claim 1, wherein an edge at an end of each of the first partition walls and the second partition walls has a curved shape.

10. A filter which uses a resonator, the resonator comprising:
a housing which is made of a conductive material and includes one or more cavities;
a cover which is made of a conductive material and fixed to an upper portion of the cavity, and seals the cavity;
one or more first partition walls which are connected to one surface of inner surfaces of the cavity;
one or more second partition walls which are connected to the opposite surface to the one surface; and
a connector which inputs and outputs a signal,
wherein the first partition walls and the second partition walls are made of a conductive material and have shapes corresponding to each other, and the first partition walls and the second partition walls alternate with each other.

11. The filter of claim 10, wherein the first partition walls are connected to the lower surface of the inner surfaces of the cavity and form lower partition walls, the second partition walls are connected to the cover and form upper partition walls, and the lower partition walls and the upper partition walls vertically alternate with each other.

12. The filter of claim 10, wherein the first partition walls and the second partition walls have a circular pipe shape, a polygonal pipe shape, a flat shape or a curved shape.

13. The filter of claim 10, further comprising:
a tuning bolt which tunes frequency properties of the filter.
